(19) United States
(12) Patent Application Publication
(10) Pub. No.: US 2026/0037137 A1
(43) Pub. Date: Feb. 5, 2026

(54) HIGH RELIABILITY MEDIA MANAGEMENT OPERATIONS

(71) Applicant: Micron Technology, Inc., Boise, ID (US)

(72) Inventors: Peng Zhang, Los Altos, CA (US); Murong Lang, San Jose, CA (US); Zhenming Zhou, San Jose, CA (US); Hanping Chen, San Jose, CA (US)

(21) Appl. No.: 18/791,179

(22) Filed: Jul. 31, 2024

(51) Int. Cl. G06F 3/06

(52) U.S. Cl. CPC G06F 3/0614; G06F 3/0652; G06F 3/0655; G06F 3/0679

(57) ABSTRACT

A system comprises a memory device and a processing device, which is coupled to the memory device. The processing device receives a request to perform a write operation. The processing device determines whether the write operation is part of a media management operation. Responsive to determining the write operation is part of the media management operation, the processing device executes the write operation with a high reliability set of trim values, wherein the high reliability set of trim values corresponds to a higher latency value relative to a default latency value.

### TECHNICAL FIELD

Embodiments of the disclosure relate generally to memory sub-systems, and more specifically, relate to performing high reliability media management operations.

### BACKGROUND

A memory sub-system can include one or more memory devices that store data. The memory devices can be, for example, non-volatile memory devices and volatile memory devices. In general, a host system can utilize a memory sub-system to store data at the memory devices and to retrieve data from the memory devices.

### BRIEF DESCRIPTION OF THE DRAWINGS

The disclosure will be understood more fully from the detailed description given below and from the accompanying drawings of various embodiments of the disclosure. The drawings, however, should not be taken to limit the disclosure to the specific embodiments, but are for explanation and understanding only.

FIG. 1 illustrates an example computing system that includes a memory sub-system in accordance with some embodiments of the present disclosure.

FIG. 2 is a flow diagram of an example method for executing media management operations with high reliability trim values, in accordance with some embodiments of the present disclosure.

FIG. 3 illustrates example write operations and the effect of applying a lower program voltage step than that of a default set of trim values.

FIG. 4 is a block diagram of an example computer system in which embodiments of the present disclosure may operate.

### DETAILED DESCRIPTION

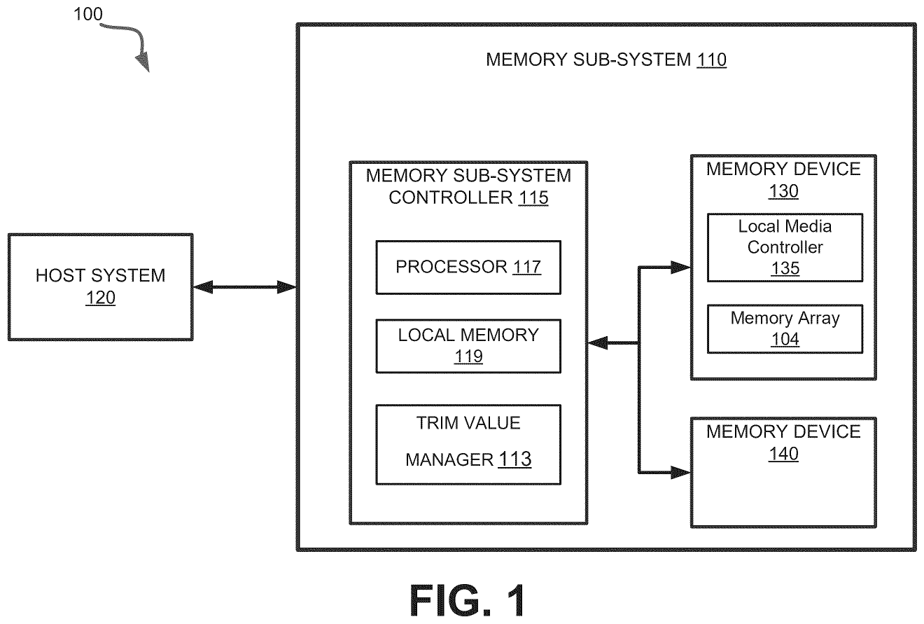

Aspects of the present disclosure are directed to performing high reliability media management operations. A memory sub-system can be a storage device, a memory module, or a combination of a storage device and memory module. Examples of storage devices and memory modules are described below in conjunction with FIG. 1. In general, a host system can utilize a memory sub-system that includes one or more components, such as memory devices that store data. The host system can provide data to be stored at the memory sub-system and can request data to be retrieved from the memory sub-system.

A memory sub-system can include high density non-volatile memory devices where retention of data is desired when no power is supplied to the memory device. One example of non-volatile memory devices is a not-and (NAND) memory device. Other examples of non-volatile memory devices are described below in conjunction with FIG. 1. A non-volatile memory device is a package of one or more dies. Each die can includes of one or more planes. For some types of non-volatile memory devices (e.g., NAND devices), each plane includes of a set of physical blocks. Each block includes of a set of pages. Each page includes of a set of memory cells (“cells”). A cell is an electronic circuit that stores information. Depending on the cell type, a cell can store one or more bits of binary information, and has various logic states that correlate to the number of bits being stored. The logic states can be represented by binary values, such as “0” and “1”, or combinations of such values.

A memory device can include multiple memory cells arranged in a two-dimensional or a three-dimensional grid. The memory cells can be formed onto a silicon wafer in an array of columns and rows. A bitline can refer to one or more conductive lines coupled to a column of associated memory cells in a memory device. A wordline can refer to one or more conductive lines coupled to a row of associated memory cells in a memory device that are used with one or more bitlines to generate the address of each of the memory cells. The intersection of a bitline and a wordline constitutes the address of the memory cell. A block hereinafter refers to a unit of the memory device used to store data and can include a group of memory cells, a wordline group, a wordline, or individual memory cells. One or more blocks can be grouped together to form separate partitions (e.g., planes) of the memory device in order to allow concurrent operations to take place on each plane. The memory device can include circuitry that performs concurrent memory page accesses of two or more memory planes. For example, the memory device can include multiple access line driver circuits and power circuits that can be shared by the planes of the memory device to facilitate concurrent access of pages of two or more memory planes, including different page types. For case of description, these circuits can be generally referred to as independent plane driver circuits. Depending on the storage architecture employed, data can be stored across the memory planes (i.e., in stripes). Accordingly, one request to read a segment of data (e.g., corresponding to one or more data addresses), can result in read operations performed on two or more of the memory planes of the memory device.

Data operations can be performed by the memory sub-system. The data operations can be host-initiated operations. For example, the host system can initiate a data operation (e.g., write, read, erase, etc.) on a memory sub-system. The host system can send access requests (e.g., write command, read command) to the memory sub-system, such as to store data on a memory device at the memory sub-system and to read data from the memory device on the memory sub-system. The data to be read or written, as specified by a host request, is hereinafter referred to as “host data.” A host request can include logical address information (e.g., logical block address (LBA), namespace) for the host data, which is the location the host system associates with the host data. The logical address information (e.g., LBA, namespace) can be part of metadata for the host data. Metadata can also include error handling data (e.g., error correction code (ECC), parity code), data version (e.g., used to distinguish age of data written), valid bitmap (which LBAs or logical transfer units contain valid data), etc. For example, upon reading data from a memory device, the memory sub-system controller can perform an error detection and correction operation. The error detection and correction operation includes identifying one or more errors (e.g., bit flip errors) in the read data. The memory sub-system can have the ability to correct a certain number of errors per management unit (e.g., using an error correction code (ECC)). As long as the number of errors in the management unit is within the ECC capability of the memory sub-system, the errors can be corrected before the data is provided to the requestor (e.g., the host system). The fraction of bits that contain incorrect data before applying ECC is called the raw bit error rate (RBER). The fraction of bits that contain incorrect data after applying ECC is called the uncorrectable bit error rate (UBER).

A memory device includes multiple memory cells, each of which can store, depending on the memory cell type, one or more bits of information. A memory cell can be programmed (written to) by applying a certain voltage to the memory cell, which results in an electric charge being held by the memory cell, thus allowing modulation of the voltage distributions produced by the memory cell. Moreover, precisely controlling the amount of the electric charge stored by the memory cell allows the establishment of multiple threshold voltage levels corresponding to different logical levels, thus effectively allowing a single memory cell to store multiple bits of information. For example, a memory cell operated with 2n different threshold voltage levels is capable of storing n bits of information. Thus, the read operation can be performed by comparing the measured voltage exhibited by the memory cell to one or more reference read voltage levels in order to distinguish between two logical levels for single-level cells and between multiple logical levels for multi-level cells. The read reference voltages and the state widths of the threshold voltage distributions determine the edge margins available. The even edges determine the margin for program disturb and over-program, while the odd edges determine the margin for charge loss. The sum of all edge margins is usually defined as the read window budget (RWB). Therefore, a larger window allows larger margins, e.g., to read the cell correctly in the event of charge loss or disturb/over-program.

The reliability of a NAND device, however, decreases with increase in program-erase cycles (PEC). This degradation can occur due to wear that occurs with each cycle, impacting the physical integrity of the memory cells. As memory cells are repeatedly written to and erased, the distinct voltage distributions that represent different data states can begin to overlap. This overlap, often exacerbated by cell wear, leads to increased error rates as it becomes more challenging for the device to distinguish between these states accurately. Consequently, this results in a higher trigger rate for error correction operations and, as a result, increased latency.

In order to maintain reliability, memory devices employ techniques to improve reliability, often sacrificing host performance as a result. Typically, these techniques toggle the trade-off between reliability and performance under varying conditions such as the number of program-crase cycles (PECs) on a memory device and temperatures. While these features significantly enhance reliability by adjusting the programming processes to prevent data corruption and extend cell life, they inevitably lead to degraded host write performance. This results in slower write speeds and less predictable system behavior, impacting overall device efficiency and a memory device's ability to meet performance specifications.

Aspects of the present disclosure address the above and other deficiencies by employing higher latency trim values during media management operations, improving reliability without hindering host write performance. “Trim values” may refer to values related to programming pulse characteristics such as ramp up time, start voltage, program step voltage, or the like. One or more sets of trim values may be stored by the memory device. Each set of trim values defines characteristics of unique programming pulses. Upon receiving a request to perform a write operation, the processing device determines whether the write operation is part of a media management operation or if it is a part of a host write operation. If the processing device finds the write operation to be part of a media management operation, the processing device applies a high reliability set of trim values to the write operation, allowing for greater reliability for write operations during the media management operations. In some embodiments, with write operations not associated with a media management operation (e.g., associated with a host operation), the processing device applies a lower latency, default, set of trim values so as not to detrimentally impact host write performance.

Advantages of the present disclosure include, but are not limited to, maintained performance, increased reliability, improved latency, decreased write amplification, and improved total bytes written. By applying higher latency operations to media management operations (e.g., folding) that typically run in the background or during idle periods, host write performance remains unaffected, maintaining normal operation speeds and efficiency during host writes. In addition, the improved reliability helps to reduce the trigger rate, which in turn enhances host read performance by minimizing the frequency of error correction operations. Additionally, the invention can reduce the media management operation rate after the first media management operation as the increased reliability does not require such operations as frequently, thereby decreasing write amplification and enhancing the total bytes written to the memory device. Overall, this implementation optimizes both the durability and efficiency of memory storage systems without compromising on performance.

FIG. 1 illustrates an example computing system 100 that includes a memory sub-system 110 in accordance with some embodiments of the present disclosure. The memory sub-system 110 can include media, such as one or more volatile memory devices (e.g., memory device 140), one or more non-volatile memory devices (e.g., memory device 130), or a combination of such.

A memory sub-system 110 can be a storage device, a memory module, or a combination of a storage device and memory module. Examples of a storage device include a solid-state drive (SSD), a flash drive, a universal serial bus (USB) flash drive, an embedded Multi-Media Controller (eMMC) drive, a Universal Flash Storage (UFS) drive, a secure digital (SD) card, and a hard disk drive (HDD). Examples of memory modules include a dual in-line memory module (DIMM), a small outline DIMM (SO-DIMM), and various types of non-volatile dual in-line memory modules (NVDIMMs).

The computing system 100 can be a computing device such as a desktop computer, laptop computer, network server, mobile device, a vehicle (e.g., airplane, drone, train, automobile, or other conveyance), Internet of Things (IoT) enabled device, embedded computer (e.g., one included in a vehicle, industrial equipment, or a networked commercial device), or such computing device that includes memory and a processing device.

The computing system 100 can include a host system 120 that is coupled to one or more memory sub-systems 110. In some embodiments, the host system 120 is coupled to multiple memory sub-systems 110 of different types. FIG. 1 illustrates one example of a host system 120 coupled to one memory sub-system 110. As used herein, “coupled to” or “coupled with” generally refers to a connection between components, which can be an indirect communicative connection or direct communicative connection (e.g., without intervening components), whether wired or wireless, including connections such as electrical, optical, magnetic, etc.

The host system 120 can include a processor chipset and a software stack executed by the processor chipset. The processor chipset can include one or more cores, one or more caches, a memory controller (e.g., NVDIMM controller), and a storage protocol controller (e.g., PCIe controller, SATA controller, CXL controller). The host system 120 uses the memory sub-system 110, for example, to write data to the memory sub-system 110 and read data from the memory sub-system 110.

The host system 120 can be coupled to the memory sub-system 110 via a physical host interface. Examples of a physical host interface include, but are not limited to, a serial advanced technology attachment (SATA) interface, a compute express link (CXL) interface, a peripheral component interconnect express (PCIe) interface, universal serial bus (USB) interface, Fibre Channel, Serial Attached SCSI (SAS), a double data rate (DDR) memory bus, Small Computer System Interface (SCSI), a dual in-line memory module (DIMM) interface (e.g., DIMM socket interface that supports Double Data Rate (DDR)), etc. The physical host interface can be used to transmit data between the host system 120 and the memory sub-system 110. The host system 120 can further utilize an NVM Express (NVMe) interface to access components (e.g., memory devices 130) when the memory sub-system 110 is coupled with the host system 120 by the physical host interface (e.g., PCIe or CXL bus). The physical host interface can provide an interface for passing control, address, data, and other signals between the memory sub-system 110 and the host system 120. FIG. 1 illustrates a memory sub-system 110 as an example. In general, the host system 120 can access multiple memory sub-systems via a same communication connection, multiple separate communication connections, and/or a combination of communication connections.

The memory devices 130, 140 can include any combination of the different types of non-volatile memory devices and/or volatile memory devices. The volatile memory devices (e.g., memory device 140) can be, but are not limited to, random access memory (RAM), such as dynamic random access memory (DRAM) and synchronous dynamic random access memory (SDRAM).

Some examples of non-volatile memory devices (e.g., memory device 130) include a not- and (NAND) type flash memory and write-in-place memory, such as a three-dimensional cross-point (“3D cross-point”) memory device, which is a cross-point array of non-volatile memory cells. A cross-point array of non-volatile memory cells can perform bit storage based on a change of bulk resistance, in conjunction with a stackable cross-gridded data access array. Additionally, in contrast to many flash-based memories, cross-point non-volatile memory can perform a write in-place operation, where a non-volatile memory cell can be programmed without the non-volatile memory cell being previously erased. NAND type flash memory includes, for example, two-dimensional NAND (2D NAND) and three-dimensional NAND (3D NAND).

Each of the memory devices 130 can include one or more arrays of memory cells. One type of memory cell, for example, single level cells (SLC) can store one bit per cell. Other types of memory cells, such as multi-level cells (MLCs), triple level cells (TLCs), quad-level cells (QLCs), and penta-level cells (PLCs) can store multiple bits per cell. In some embodiments, each of the memory devices 130 can include one or more arrays of memory cells such as SLCs, MLCs, TLCs, QLCs, PLCs or any combination of such. In some embodiments, a particular memory device can include an SLC portion, and an MLC portion, a TLC portion, a QLC portion, or a PLC portion of memory cells. The memory cells of the memory devices 130 can be grouped as pages that can refer to a logical unit of the memory device used to store data. With some types of memory (e.g., NAND), pages can be grouped to form blocks.

Although non-volatile memory components such as a 3D cross-point array of non-volatile memory cells and NAND type flash memory (e.g., 2D NAND, 3D NAND) are described, the memory device 130 can be based on any other type of non-volatile memory, such as read-only memory (ROM), phase change memory (PCM), self-selecting memory, other chalcogenide based memories, ferroelectric transistor random-access memory (FeTRAM), ferroelectric random access memory (FeRAM), magneto random access memory (MRAM), Spin Transfer Torque (STT)-MRAM, conductive bridging RAM (CBRAM), resistive random access memory (RRAM), oxide based RRAM (OxRAM), not- or (NOR) flash memory, or electrically erasable programmable read-only memory (EEPROM).

A memory sub-system controller 115 (or controller 115 for simplicity) can communicate with the memory devices 130 to perform operations such as reading data, writing data, or erasing data at the memory devices 130 and other such operations. The memory sub-system controller 115 can include hardware such as one or more integrated circuits and/or discrete components, a buffer memory, or a combination thereof. The hardware can include a digital circuitry with dedicated (i.e., hard-coded) logic to perform the operations described herein. The memory sub-system controller 115 can be a microcontroller, special purpose logic circuitry (e.g., a field programmable gate array (FPGA), an application specific integrated circuit (ASIC), etc.), or other suitable processor.

The memory sub-system controller 115 can include a processing device, which includes one or more processors (e.g., processor 117), configured to execute instructions stored in a local memory 119. In the illustrated example, the local memory 119 of the memory sub-system controller 115 includes an embedded memory configured to store instructions for performing various processes, operations, logic flows, and routines that control operation of the memory sub-system 110, including handling communications between the memory sub-system 110 and the host system 120.

In some embodiments, the local memory 119 can include memory registers storing memory pointers, fetched data, etc. The local memory 119 can also include read-only memory (ROM) for storing micro-code. While the example memory sub-system 110 in FIG. 1 has been illustrated as including the memory sub-system controller 115, in another embodiment of the present disclosure, a memory sub-system 110 does not include a memory sub-system controller 115, and can instead rely upon external control (e.g., provided by an external host, or by a processor or controller separate from the memory sub-system).

In general, the memory sub-system controller 115 can receive commands or operations from the host system 120 and can convert the commands or operations into instructions or appropriate commands to achieve the desired access to the memory devices 130. The memory sub-system controller 115 can be responsible for other operations such as wear leveling operations, garbage collection operations, error detection and error-correcting code (ECC) operations, encryption operations, caching operations, and address translations between a logical address (e.g., a logical block address (LBA), namespace) and a physical address (e.g., physical block address) that are associated with the memory devices 130. The memory sub-system controller 115 can further include host interface circuitry to communicate with the host system 120 via the physical host interface. The host interface circuitry can convert the commands received from the host system into command instructions to access the memory devices 130 as well as convert responses associated with the memory devices 130 into information for the host system 120.

The memory sub-system 110 can also include additional circuitry or components that are not illustrated. In some embodiments, the memory sub-system 110 can include a cache or buffer (e.g., DRAM) and address circuitry (e.g., a row decoder and a column decoder) that can receive an address from the memory sub-system controller 115 and decode the address to access the memory devices 130.

In some embodiments, the memory devices 130 include local media controllers 135 that operate in conjunction with memory sub-system controller 115 to execute operations on one or more memory cells of the memory devices 130. An external controller (e.g., memory sub-system controller 115) can externally manage the memory device 130 (e.g., perform media management operations on the memory device 130). In some embodiments, memory sub-system 110 is a managed memory device, which is a raw memory device 130 having control logic (e.g., local media controller 135) on the die and a controller (e.g., memory sub-system controller 115) for media management within the same memory device package. An example of a managed memory device is a managed NAND (MNAND) device.

The memory sub-system 110 includes a trim value manager component 113 that can selectively implement high reliability media management operations. In some embodiments, the memory sub-system controller 115 includes at least a portion of the trim value manager component 113. In some embodiments, the trim value manager component 113 is part of the host system 120, an application, or an operating system. In other embodiments, local media controller 135 includes at least a portion of trim value manager component 113 and is configured to perform the functionality described herein.

The trim value manager component 113 can selectively implement high reliability management operations. Upon receiving a request to perform a write operation, the processing device determines whether the write operation is part of a media management operation or if it is a part of a host operation. If the processing device finds the write operation to be part of a media management operation, the processing device applies a higher latency, high reliability, set of trim values to the write operation, allowing for greater reliability for write operations during the media management operations. Further details with regards to the operations of the trim value manager component 113 are described below.

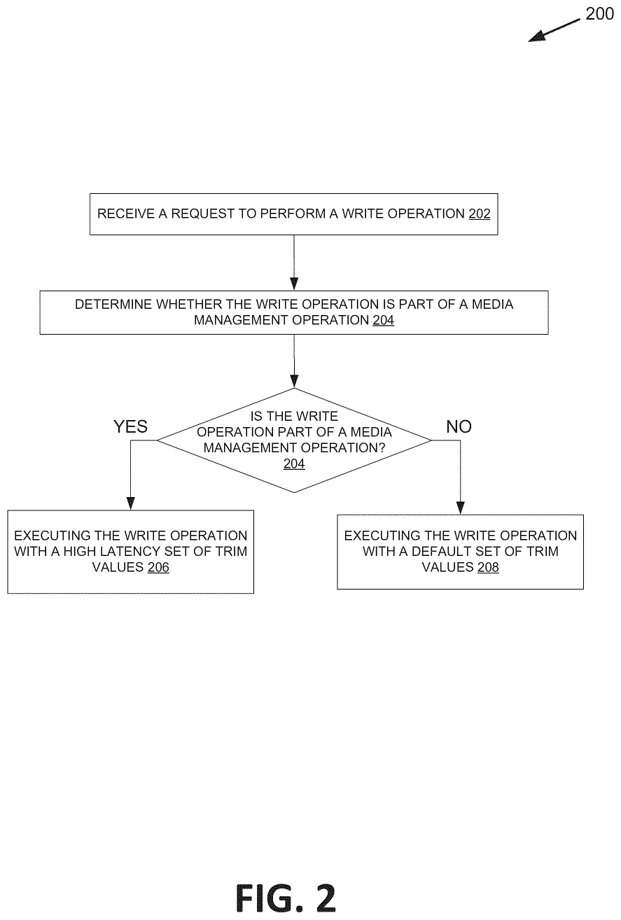

FIG. 2 is a flow diagram of an example method 200 for executing media management operations with high reliability trim values, in accordance with some embodiments of the present disclosure. The method 200 can be performed by processing logic that can include hardware (e.g., processing device, circuitry, dedicated logic, programmable logic, microcode, hardware of a device, integrated circuit, etc.), software (e.g., instructions run or executed on a processing device), or a combination thereof. In some embodiments, the method 200 is performed by the trim value manager component 113 of FIG. 1. Although shown in a particular sequence or order, unless otherwise specified, the order of the processes can be modified. Thus, the illustrated embodiments should be understood only as examples, and the illustrated processes can be performed in a different order, and some processes can be performed in parallel. Additionally, one or more processes can be omitted in various embodiments. Thus, not all processes are required in every embodiment. Other process flows are possible.

At operation 202, the processing logic (e.g., trim value manager component 113) receives a request to perform a write operation. In some embodiments, this request originates from the system. In some embodiments, this request is triggered as part of a media management operation.

At operation 204, the processing logic determines whether the write operation is part of a media management operation. Possible media management operations include “folding.” Folding is a media management operation performed by the processing logic involving rearranging and consolidating memory to clear space occupied by “garbage” (invalid) data that is no longer in use. Folding merges smaller memory chunks comprising valid data into larger available blocks to minimize fragmentation and wasted space in the memory device.

In embodiments implementing a folding media management operation, the processing logic performs a read operation on the valid data (e.g., up to date, in-use data) from a “victim” set of memory cells. The processing logic performs a write operation on an available set of memory cells, to write data from the victim set of memory cells into the available set of memory cells. The processing logic performs an erase operation on the victim set of memory cells.

In some embodiments, the victim set of memory cells and the available set of memory cells are configured to store different numbers of bits per cell. For example, the victim set of memory cells can be configured as Single-Level Cell (SLC) memory, which stores one bit per cell, while the available set of memory cells can be configured as Triple-Level Cell (TLC) memory, which stores three bits per cell. In some embodiments, the victim set of memory cells and the available set of memory cells are configured to store an equal number of bits per cell. For example, the victim set of memory cells and the available set of memory cells can be configured as Triple-Level Cell (TLC) memory, storing three bits per cell.

In some embodiments, determining whether the write operation is part of a media management operation comprises determining whether the request to perform a write operation refers to a media management operation cursor. A media management operation cursor is an indicator associated with a media management operation write operation. In embodiments, it can be used to direct the movement of data into memory cells by the system. In some embodiments, this cursor is used to determine whether the write operation is part of a media management operation, and not part of a host write operation (so as not to affect host write performance).

Responsive to determining the write operation is part of the media management operation, at operation 206, the processing logic executes the write operation with a high reliability set of trim values. In embodiments, the high reliability set of trim values corresponds to a higher latency value relative to a default latency value. In embodiments, the default latency value is based upon the latency of the trim values for host write operations.

“Trim values” refer to values related to programming pulse characteristics such as ramp up time, start voltage, program step voltage, or the like. One or more sets of trim values may be stored by the memory device. Each set of trim values defines characteristics of unique programming pulses. Upon receiving a request to perform a write operation, the processing device determines whether the write operation is part of a media management operation or if it is a part of a host write operation. If the processing device finds the write operation to be part of a media management operation, the processing device uses a higher latency, high reliability set of trim values for the write operation, allowing for greater reliability for write operations during the media management operations.

In some embodiments, executing the write operation with a high reliability set of trim values involves modifying a default set of trim values in a metadata table. The metadata table contains values corresponding to the execution of the write operation. For example, upon executing the write operation with the high reliability set of trim values, the processing logic modifies the set of trim values currently stored in the metadata table to reflect the change until further modification is requested. Additionally, in some embodiments, the high reliability set of trim values in the metadata table are modified to an appropriate set of trim values.

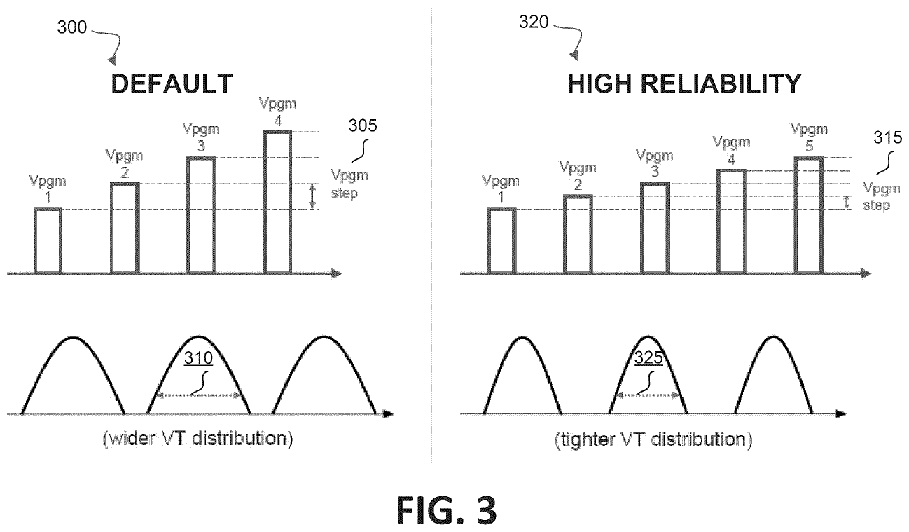

In some embodiments, the high reliability set of trim values comprises a lower program voltage step than the default set of trim values. FIG. 3 illustrates example write operations 300 and 320 and the effect of applying a lower program voltage step than that of a default set of trim values. Operation 300 corresponds to a write operation performed using a “Default” program voltage step trim value. Operation 320 corresponds to a write operation using the “High Reliability” program voltage step trim value.

A program voltage step (“Vpgm step”) is an incremental difference between successive voltage pulses applied to the gate of memory cells during a write operation. Step voltage programming in memory involves applying voltage pulses in small, controlled increments to adjust the threshold voltage of memory cells accurately. As depicted in operation 300, this process begins with an initial pulse, Vpgm 1, followed by verification of the cell's state. If the desired threshold is not achieved, additional pulses, known as program voltage setps, are incrementally applied (e.g., Vpgm 2, Vpgm 3, and Vpgm 4 in operation 300), iteratively increasing by a Vpgm step amount dictated by applied set of trim values. Each subsequent pulse slightly raises the voltage, allowing for fine-tuning without overshooting the target state.

As described above, operation 300 illustrates programming with a default set of trim values, using a Vpgm step 305. Operation 320 shows step voltage programming with the high reliability set of trim values, which includes a lower program voltage step 315. By decreasing the program voltage step size to program voltage step 315, tighter voltage threshold distributions (VT) such as VT 325 (in comparison to VT 310) can be attained, allowing for an improved read window budget (RWB). Reliability is improved in operation 320 as it allows larger margins between voltage threshold distributions to read the cell correctly in the event of charge loss or read disturb/over-program.

As depicted in operation 320, decreasing the program voltage step requires more program pulses to perform the same amount of programming; operation 320 depicts five voltage program steps (e.g., Vpgm 1, Vpgm 2, Vpgm 3, Vpgm 4, Vpgm 5) compared to operation 300 which depicts four. However, in embodiments, the resulting increase in the time needed to perform the program operation does not affect host write performance as the processing logic uses the high reliability set of trim values (e.g., the lower program voltage step) only for the write operations that are part of media management operations that typically run in the background or during idle periods.

In some embodiments, the high reliability set of trim values includes a program-verify level adjustment. A program-verify level is checked against by the processing logic to determine if memory cells have reached the desired voltage thresholds after each program voltage pulse. In some embodiments, the voltage offset values necessary for adjusting the program-verify level voltage and/or the program voltage are stored within the memory device's metadata. These voltage offset values are determined from threshold voltage (Vt) data, collected during program operations on one or more wordlines of the memory device.

In some embodiments, responsive to determining the write operation is not part of a media management operation, at operation 208, the processing logic executes the write operation with the default set of trim values, wherein the write operation is host-initiated. In some embodiments, the default set of trim values are predefined and stored in a metadata table for reference. In some embodiments, the default set of trim values are those used for host write operations.

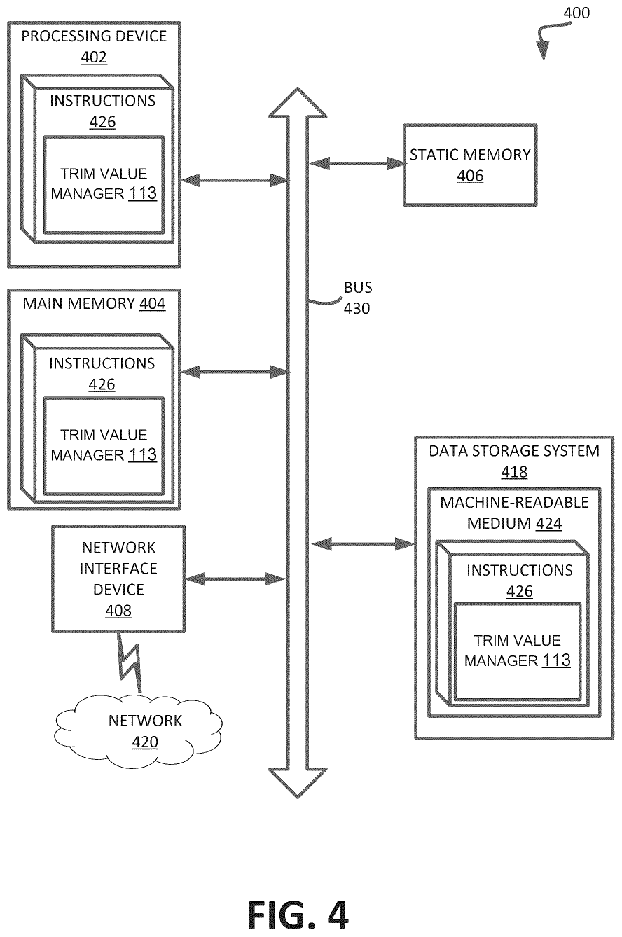

FIG. 4 illustrates an example machine of a computer system 400 within which a set of instructions, for causing the machine to perform any one or more of the methodologies discussed herein, can be executed. In some embodiments, the computer system 400 can correspond to a host system (e.g., the host system 120 of FIG. 1) that includes, is coupled to, or utilizes a memory sub-system (e.g., the memory sub-system 110 of FIG. 1) or can be used to perform the operations of a controller (e.g., to execute an operating system to perform operations corresponding to the trim value manager component 113 of FIG. 1). In alternative embodiments, the machine can be connected (e.g., networked) to other machines in a LAN, an intranet, an extranet, and/or the Internet. The machine can operate in the capacity of a server or a client machine in a client-server network environment, as a peer machine in a peer-to-peer (or distributed) network environment, or as a server or a client machine in a cloud computing infrastructure or environment.

The machine can be a personal computer (PC), a tablet PC, a set-top box (STB), a Personal Digital Assistant (PDA), a cellular telephone, a web appliance, a server, a network router, a switch or bridge, or any machine capable of executing a set of instructions (sequential or otherwise) that specify actions to be taken by that machine. Further, while a single machine is illustrated, the term “machine” shall also be taken to include any collection of machines that individually or jointly execute a set (or multiple sets) of instructions to perform any one or more of the methodologies discussed herein.

The example computer system 400 includes a processing device 402, a main memory 404 (e.g., read-only memory (ROM), flash memory, dynamic random access memory (DRAM) such as synchronous DRAM (SDRAM) or RDRAM, etc.), a static memory 406 (e.g., flash memory, static random access memory (SRAM), etc.), and a data storage system 418, which communicate with each other via a bus 430.

Processing device 402 represents one or more general-purpose processing devices such as a microprocessor, a central processing unit, or the like. More particularly, the processing device can be a complex instruction set computing (CISC) microprocessor, reduced instruction set computing (RISC) microprocessor, very long instruction word (VLIW) microprocessor, or a processor implementing other instruction sets, or processors implementing a combination of instruction sets. Processing device 402 can also be one or more special-purpose processing devices such as an application specific integrated circuit (ASIC), a field programmable gate array (FPGA), a digital signal processor (DSP), network processor, or the like. The processing device 402 is configured to execute instructions 426 for performing the operations and steps discussed herein. The computer system 400 can further include a network interface device 408 to communicate over the network 420.

The data storage system 418 can include a machine-readable storage medium 424 (also known as a computer-readable medium) on which is stored one or more sets of instructions 426 or software embodying any one or more of the methodologies or functions described herein. The instructions 426 can also reside, completely or at least partially, within the main memory 404 and/or within the processing device 402 during execution thereof by the computer system 400, the main memory 404 and the processing device 402 also constituting machine-readable storage media. The machine-readable storage medium 424, data storage system 418, and/or main memory 404 can correspond to the memory sub-system 110 of FIG. 1.

In one embodiment, the instructions 426 include instructions to implement functionality corresponding to a trim value manager component (e.g., the trim value manager component 113 of FIG. 1). While the machine-readable storage medium 424 is shown in an example embodiment to be a single medium, the term “machine-readable storage medium” should be taken to include a single medium or multiple media that store the one or more sets of instructions. The term “machine-readable storage medium” shall also be taken to include any medium that is capable of storing or encoding a set of instructions for execution by the machine and that cause the machine to perform any one or more of the methodologies of the present disclosure. The term “machine-readable storage medium” shall accordingly be taken to include, but not be limited to, solid-state memories, optical media, and magnetic media.

Some portions of the preceding detailed descriptions have been presented in terms of algorithms and symbolic representations of operations on data bits within a computer memory. These algorithmic descriptions and representations are the ways used by those skilled in the data processing arts to most effectively convey the substance of their work to others skilled in the art. An algorithm is here, and generally, conceived to be a self-consistent sequence of operations leading to a desired result. The operations are those requiring physical manipulations of physical quantities. Usually, though not necessarily, these quantities take the form of electrical or magnetic signals capable of being stored, combined, compared, and otherwise manipulated. It has proven convenient at times, principally for reasons of common usage, to refer to these signals as bits, values, elements, symbols, characters, terms, numbers, or the like.

It should be borne in mind, however, that all of these and similar terms are to be associated with the appropriate physical quantities and are merely convenient labels applied to these quantities. The present disclosure can refer to the action and processes of a computer system, or similar electronic computing device, that manipulates and transforms data represented as physical (electronic) quantities within the computer system's registers and memories into other data similarly represented as physical quantities within the computer system memories or registers or other such information storage systems.

The present disclosure also relates to an apparatus for performing the operations herein. This apparatus can be specially constructed for the intended purposes, or it can include a general purpose computer selectively activated or reconfigured by a computer program stored in the computer. Such a computer program can be stored in a computer readable storage medium, such as, but not limited to, any type of disk including floppy disks, optical disks, CD-ROMs, and magnetic-optical disks, read-only memories (ROMs), random access memories (RAMs), EPROMS, EEPROMs, magnetic or optical cards, or any type of media suitable for storing electronic instructions, each coupled to a computer system bus.

The algorithms and displays presented herein are not inherently related to any particular computer or other apparatus. Various general purpose systems can be used with programs in accordance with the teachings herein, or it can prove convenient to construct a more specialized apparatus to perform the method. The structure for a variety of these systems will appear as set forth in the description below. In addition, the present disclosure is not described with reference to any particular programming language. It will be appreciated that a variety of programming languages can be used to implement the teachings of the disclosure as described herein.

The present disclosure can be provided as a computer program product, or software, that can include a machine-readable medium having stored thereon instructions, which can be used to program a computer system (or other electronic devices) to perform a process according to the present disclosure. A machine-readable medium includes any mechanism for storing information in a form readable by a machine (e.g., a computer). In some embodiments, a machine-readable (e.g., computer-readable) medium includes a machine (e.g., a computer) readable storage medium such as a read only memory (“ROM”), random access memory (“RAM”), magnetic disk storage media, optical storage media, flash memory components, etc.

In the foregoing specification, embodiments of the disclosure have been described with reference to specific example embodiments thereof. It will be evident that various modifications can be made thereto without departing from the broader spirit and scope of embodiments of the disclosure as set forth in the following claims. The specification and drawings are, accordingly, to be regarded in an illustrative sense rather than a restrictive sense.

What is claimed is:

1. A system, comprising:
a memory device; and
a processing device, operatively coupled with the memory device, to perform operations comprising:
receiving a request to perform a write operation;
determining whether the write operation is part of a media management operation; and
responsive to determining that the write operation is part of the media management operation, executing the write operation with a high reliability set of trim values, wherein the high reliability set of trim values corresponds to a higher latency value relative to a default latency value.

2. The system of claim 1, further comprising:
responsive to determining the write operation is not part of a media management operation, executing the write operation with a default set of trim values to the write operation, wherein the write operation is host-initiated.

3. The system of claim 1, wherein the media management operation comprises:
performing a read operation on a victim set of memory cells;
performing the write operation on an available set of memory cells to write data from the victim set of memory cells, wherein the available set of memory cells has not been written to; and
performing an erase operation on the victim set of memory cells.

4. The system of claim 3, wherein the victim set of memory cells and the available set of memory cells are configured to store an equal number of bits per cell.

5. The system of claim 3, wherein the victim set of memory cells and the available set of memory cells are configured to store different numbers of bits per cell.

6. The system of claim 1, wherein determining whether the write operation is part of a media management operation comprises determining whether the request to perform a write operation refers to a media management operation cursor.

7. The system of claim 1, wherein the high reliability set of trim values comprises a lower program voltage step than a default set of trim values.

8. A method comprising:
receiving, from a processing device, a request to perform a write operation;
determining whether the write operation is part of a media management operation; and
responsive to determining that the write operation is part of the media management operation, executing the write operation with a high reliability set of trim values, wherein the high reliability set of trim values corresponds to a higher latency value relative to a default latency value.

9. The method of claim 8, further comprising:
responsive to determining the write operation is not part of a media management operation, executing the write operation with a default set of trim values, wherein the write operation is host-initiated.

10. The method of claim 8, wherein the media management operation comprises:
performing a read operation on a victim set of memory cells;
performing the write operation on an available set of memory cells to write data from the victim set of memory cells, wherein the available set of memory cells has not been written to; and
performing an erase operation on the victim set of memory cells.

11. The method of claim 10, wherein the victim set of memory cells and the available set of memory cells are configured to store an equal number of bits per cell.

12. The method of claim 10, wherein the victim set of memory cells and the available set of memory cells are configured to store different numbers of bits per cell.

13. The method of claim 8, wherein determining whether the write operation is part of a media management operation comprises determining whether the request to perform a write operation refers to a media management operation cursor.

14. The method of claim 8, wherein the high reliability set of trim values comprises a lower program voltage step than a default set of trim values.

15. A non-transitory computer-readable storage medium comprising instructions that, when executed by a processing device, cause the processing device to perform operations comprising:
receiving a request to perform a write operation;
determining whether the write operation is part of a media management operation; and
responsive to determining that the write operation is part of the media management operation, executing the write operation with a high reliability set of trim values, wherein the high reliability set of trim values corresponds to a higher latency value relative to a default latency value.

16. The non-transitory computer-readable storage medium of claim 15, further comprising:
responsive to determining the write operation is not part of a media management operation, executing the write operation with a default set of trim values, wherein the write operation is host-initiated.

17. The non-transitory computer-readable storage medium of claim 15, wherein the media management operation comprises:
performing a read operation on a victim set of memory cells;
performing the write operation on an available set of memory cells to write data from the victim set of memory cells, wherein the available set of memory cells has not been written to; and
performing an erase operation on the victim set of memory cells.

18. The non-transitory computer-readable storage medium of claim 17, wherein the victim set of memory cells and the available set of memory cells are configured to store an equal number of bits per cell.

19. The non-transitory computer-readable storage medium of claim 17, wherein the victim set of memory cells and the available set of memory cells are configured to store different numbers of bits per cell.

20. The non-transitory computer-readable storage medium of claim 15, wherein the high reliability set of trim values comprises a lower program voltage step than a default set of trim values.
